(19) United States
(12) Patent Application Publication
(10) Pub. No.: US 2021/0342522 A1
(43) Pub. Date: Nov. 4, 2021

(54) DYNAMIC ACCESSIBILITY COMPLIANCE OF A WEBSITE

(71) Applicant: Truabilities, LLC, Las Vegas, NV (US)

(72) Inventors: Vikas Khorana, Las Vegas, NV (US); Ryan Christiansen, Las Vegas, NV (US)

(21) Appl. No.: 17/244,581

(22) Filed: Apr. 29, 2021

Related U.S. Application Data
(60) Provisional application No. 63/018,361, filed on Apr. 30, 2020.

(51) Int. Cl. G06F 40/166; H04L 29/08; G06F 3/0481

(52) U.S. Cl. CPC G06F 40/166; H04L 67/02; G06F 2203/04806; G06F 3/0481; H04L 67/306

(57) ABSTRACT

Methods, systems, and devices for dynamic accessibility compliance of a website are described. The method may include identifying a request to load a web page on a web browser, identifying a request from source code of the web page to retrieve web content, integrating an accessibility widget within the web content based on identifying the request from the source code to retrieve the web content, displaying the web content amongst page content of the web page, and modifying at least one of the one or more aspects of the web content based on a user profile associated with the accessibility widget.

The present application for patent claims priority to U.S. Provisional Patent Application No. 63/018,361 by Khorana et al., entitled “DYNAMIC ACCESSIBILITY COMPLIANCE OF A WEBSITE”, filed Apr. 30, 2020, which is assigned to the assignee hereof and is expressly incorporated by reference in its entirety.

### BACKGROUND

### Cross Reference

The following relates generally to dynamic accessibility compliance of a website or advertisement.

The use of computer systems and computer-related technologies continues to increase at a rapid pace. This increased use of computer systems has influenced the advances made to computer-related technologies. Computer systems have increasingly become an integral part of the business world and the activities of individual consumers. Computer systems may be used to carry out several business, industry, and academic endeavors.

The wide-spread use of computers and mobile devices has caused an increased presence of Internet websites. However, many of these websites are not designed to be easily browsed by those with disabilities. It is estimated that one in every five people experiences some sort of permanent or temporary disability with vision, hearing, or mobility, etc., resulting in a poor user experience for many online users visiting website.

### SUMMARY

The described techniques relate to improved methods, systems, devices, or apparatuses that support dynamic accessibility compliance of a website. Generally, the described techniques include mechanisms for providing accessibility compliance dynamically for web content accessed via an Internet browser. The techniques described herein enable a website to add accessibility compliance to external content retrieved from third-party servers and integrated with content of a web page of the website.

A method of dynamic accessibility compliance of a website is described. The method may include identifying a request to load a web page on a web browser, identifying a request from source code of the web page to retrieve web content, integrating an accessibility widget within the web content based on identifying the request from the source code to retrieve the web content, displaying the web content amongst page content of the web page, and modifying at least one of the one or more aspects of the web content based on a user profile associated with the accessibility widget.

An apparatus for dynamic accessibility compliance of a website is described. The apparatus may include a processor, memory coupled with the processor, and instructions stored in the memory. The instructions may be executable by the processor to cause the apparatus to identify a request to load a web page on a web browser, identify a request from source code of the web page to retrieve web content, integrate an accessibility widget within the web content based on identifying the request from the source code to retrieve the web content, display the web content amongst page content of the web page, and modify at least one of the one or more aspects of the web content based on a user profile associated with the accessibility widget.

Another apparatus for dynamic accessibility compliance of a website is described. The apparatus may include means for identifying a request to load a web page on a web browser, identifying a request from source code of the web page to retrieve web content, integrating an accessibility widget within the web content based on identifying the request from the source code to retrieve the web content, displaying the web content amongst page content of the web page, and modifying at least one of the one or more aspects of the web content based on a user profile associated with the accessibility widget.

A non-transitory computer-readable medium storing code for dynamic accessibility compliance of a website is described. The code may include instructions executable by a processor to identify a request to load a web page on a web browser, identify a request from source code of the web page to retrieve web content, integrate an accessibility widget within the web content based on identifying the request from the source code to retrieve the web content, display the web content amongst page content of the web page, and modify at least one of the one or more aspects of the web content based on a user profile associated with the accessibility widget.

Some examples of the method, apparatuses, and non-transitory computer-readable medium described herein may further include operations, features, means, or instructions for modifying one or more aspects of the page content based on the user profile associated with the accessibility widget.

Some examples of the method, apparatuses, and non-transitory computer-readable medium described herein may further include operations, features, means, or instructions for modifying the one or more aspects of the web content or the one or more aspects of the page content includes at least one of modifying a text spacing, or modifying a text size, or underlining a link, or magnifying at least a portion of text, or modifying a color scheme, or converting one or more colors to grayscale, or inverting one or more colors, or any combination thereof.

Some examples of the method, apparatuses, and non-transitory computer-readable medium described herein may further include operations, features, means, or instructions for automatically reading aloud, based on the user profile, text of the web content or text of the page content using a text-to-speech computer process of the accessibility widget.

Some examples of the method, apparatuses, and non-transitory computer-readable medium described herein may further include operations, features, means, or instructions for selecting content to include in the web content based on the user profile.

Some examples of the method, apparatuses, and non-transitory computer-readable medium described herein may further include operations, features, means, or instructions for blocking content from being included in the web content based on the user profile.

Some examples of the method, apparatuses, and non-transitory computer-readable medium described herein may further include operations, features, means, or instructions for deleting, after closing the web page, user data associated with the web page based on the user profile.

In some examples of the method, apparatuses, and non-transitory computer-readable medium described herein, integrating the accessibility widget into the web content may include operations, features, means, or instructions for embedding source code of the accessibility widget into source code of the web content.

In some examples of the method, apparatuses, and non-transitory computer-readable medium described herein, displaying the web content may include operations, features, means, or instructions for displaying an interactive user interface of the accessibility widget that may be configured to open a menu of the accessibility widget, where the menu includes settings of the user profile.

In some examples of the method, apparatuses, and non-transitory computer-readable medium described herein, loading the web page may include operations, features, means, or instructions for downloading and displaying the page content in the web browser.

In some examples of the method, apparatuses, and non-transitory computer-readable medium described herein, at least a portion of the page content may be downloaded from a first server, and where at least a portion of the web content may be retrieved from a second server different from the first server.

### BRIEF DESCRIPTION OF THE DRAWINGS

FIG. 1 illustrates an example of a system that supports dynamic accessibility compliance of a website in accordance with aspects of the present disclosure.

FIG. 2 illustrates an example of a web page that supports dynamic accessibility compliance of a website in accordance with aspects of the present disclosure.

FIG. 3 illustrates an example of a network architecture that supports dynamic accessibility compliance of a website in accordance with aspects of the present disclosure.

FIGS. 4 and 5 show block diagrams of devices that support dynamic accessibility compliance of a website in accordance with aspects of the present disclosure.

FIG. 6 shows a block diagram of a compliance manager that supports dynamic accessibility compliance of a website in accordance with aspects of the present disclosure.

FIG. 7 shows a diagram of a system including a device that supports dynamic accessibility compliance of a website in accordance with aspects of the present disclosure.

FIGS. 8 and 9 show flowcharts illustrating methods that support dynamic accessibility compliance of a website in accordance with aspects of the present disclosure.

### DETAILED DESCRIPTION

In some examples, a website may include a web page (e.g., one or more web pages). In some examples, the web page may include page content (e.g., the main content of the web page). For example, the main content of a web page of a news website may include news content (e.g., text of a news article, images of a news article, etc.), or the main content of a calendar web page may include calendar content (e.g., a monthly calendar, a daily schedule, list of appointments, etc.), or the main content of a media web page may include media content (e.g., video media, audio media, video streaming media player, audio streaming media player, etc.), or the main content of a web page of an email website may include email content (e.g., received emails, draft emails, an email inbox, etc.).

In some examples, external content (e.g., text, image files, media player, script code, source code, hypertext markup language code, cascade style sheet code, etc.) retrieved from a third-party server and integrated with the page content of the web page. In some examples, the described techniques enable the website to add accessibility compliance to the external content. In some examples, the described techniques may integrate accessibility compliance into the page content of the web page. In some examples, the external content may have no accessibility compliance or may not have the same level of accessibility compliance as that of the page content. Accordingly, the techniques described herein may include adding accessibility compliance to the external content. In some examples, the techniques described herein may include providing the same level of accessibility compliance in the external content as with the page content.

Aspects of the disclosure are initially described in the context of a system. Aspects of the disclosure are further illustrated by and described with reference to a web page and a network architecture. Aspects of the disclosure are further illustrated by and described with reference to apparatus diagrams, system diagrams, and flowcharts that relate to dynamic accessibility compliance of a website

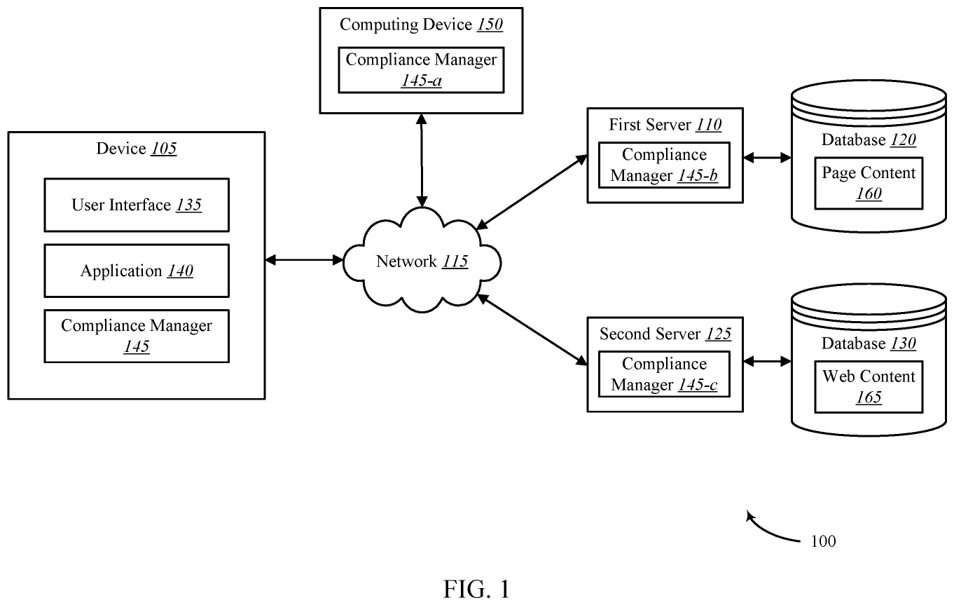

FIG. 1 illustrates a block diagram illustrating one example of a compliance system 100 in which the present systems and methods may be implemented. In some examples, the systems and methods described herein may be performed on a device (e.g., device 105). As depicted, the compliance system 100 may include a device 105, first server 110, second server 125, a computing device 150, and a network 115 that allows the device 105, the first server 110, the second server 125, and the computing device 150 to communicate with one another.

Examples of the device 105 may include any combination of, for example, mobile devices, smart phones, personal computing devices, computers, laptops, desktops, servers, media content set top boxes, or any combination thereof.

Examples of computing device 150 may include at least one of one or more client machines, one or more mobile computing devices, one or more laptops, one or more desktops, one or more servers, one or more media set top boxes, or any combination thereof.

Examples of first server 110 or second server 125 may include, for example, a data server, a cloud server, proxy server, mail server, web server, application server, database server, communications server, file server, home server, mobile server, name server, or any combination thereof.

Although computing device 150 is depicted as connecting to device 105 via network 115, in some examples, device 105 may connect directly to computing device 150. In some examples, device 105 may connect or attach to at least one of computing device 150 or first server 110 or second server 125 via a wired or wireless connection, or both. In some examples, device 105 may attach to any combination of a port, socket, and slot of computing device 150 or first server 110 or second server 125.

In some configurations, the device 105 may include a user interface 135, application 140, and compliance manager 145. Although the components of the device 105 are depicted as being internal to the device 105, it is understood that one or more of the components may be external to the device 105 and connect to device 105 through wired or wireless connections, or both. Examples of application 140 may include a web browser, a software application, a desktop application, a mobile application, etc. In some examples, application 140 may be installed on computing device 150 in order to allow a user to interface with a function of device 105, compliance manager 145, computing device 150, first server 110, or second server 125.

Although device 105 is illustrated with an exemplary single application 140, in some examples application 140 may represent two or more different applications installed on, running on, or associated with device 105. In some examples, application 140 may include one or more software widgets. In some cases, application 140 may include source code of a software widget. In some examples, the one or more software widgets may include, for example, script code, hypertext markup language code, procedural computer programming code, compiled computer program code, object code, uncompiled computer program code, object-oriented program code, class-based programming code, cascading style sheets code, or any combination thereof. In some examples, the software widget may include an applet installed on device 105. In some examples, the software widget may include an extension (e.g., software module), or plug-in, or add-on, added to or integrated with a software application of device 105 (e.g., integrated with a web browser, etc.). In some examples, device 105 may download the one or more software widgets from first server 110, or from second server 125, or from another server (e.g., a third server not shown).

In some examples, device 105 may communicate with first server 110 via network 115. Examples of network 115 may include any combination of cloud networks, local area networks (LAN), wide area networks (WAN), virtual private networks (VPN), wireless networks (using 802.11, for example), cellular networks (using 3G, LTE, or 5G, for example), etc. In some configurations, the network 115 may include the Internet. In some examples, the device 105 may not include compliance manager 145. For example, device 105 may include application 140 that allows device 105 to interface with a separate device via compliance manager 145 being located on another device such as computing device 150 or first server 110 or second server 125, or any combination thereof.

In some examples, at least one of device 105, computing device 150, first server 110, and second server 125 may include compliance manager 145 where at least a portion of the functions of compliance manager 145 are performed separately or concurrently on device 105, computing device 150, first server 110, or second server 125. In some examples, a user may access the functions of device 105 (directly or through device 105 via compliance manager 145) from computing device 150, or first server 110, or second server 125. In some examples, computing device 150 includes a mobile application that interfaces with one or more functions of device 105, compliance manager 145, or first server 110, or second server 125.

In some examples, first server 110 may be coupled to database 120. Database 120 may be internal or external to the first server 110. In one example, device 105 may be coupled to database 120. In some examples, database 120 may be internally or externally connected directly to device 105. Additionally or alternatively, database 120 may be internally or externally connected directly to computing device 150 or one or more network devices such as a gateway, switch, router, intrusion detection system, etc. Database 120 may include page content 160. In some examples, device 105 may access or download page content 160 from database 120 over network 115 via first server 110. Page content 160 may include data regarding content of a web page (e.g., source code, text, text files, image files, etc.). In some examples, page content 160 may include source of or associated with a web page. In some examples, page content 160 or source code of page content 160 or source code of the web page associated with page content 160 may include script code, hypertext markup language code, procedural computer programming code, compiled computer program code, object code, uncompiled computer program code, object-oriented program code, class-based programming code, cascading style sheets code, or any combination thereof.

In some examples, second server 125 may be coupled to database 130. Database 130 may be internal or external to the second server 125. In one example, device 105 may be coupled to database 130. In some examples, database 130 may be internally or externally connected directly to device 105. Additionally or alternatively, database 130 may be internally or externally connected directly to computing device 150 or one or more network devices such as a gateway, switch, router, intrusion detection system, etc. Database 130 may include web content 165. In some examples, device 105 may access or download web content 165 from database 130 over network 115 via second server 125. Web content 165 may include data that is retrieved or downloaded from a server (e.g., from the Internet, from second server 125), and integrated with content of a web page (e.g., integrated with page content 160).

In some examples, web content 165 may include, for example, at least one of text, image files, media player, script code, source code, hypertext markup language code, cascade style sheet code, or any combination thereof retrieved from a third-party server (e.g., second server 125) different from a server (e.g., first server 110) that serves page content of a web page (e.g., page content 160). In some examples, web content 165 may be integrated with page content 160 of the web page. In some examples, web content 165 or source code of web content 165 may include script code, hypertext markup language code, procedural computer programming code, compiled computer program code, object code, uncompiled computer program code, object-oriented program code, class-based programming code, cascading style sheets code, or any combination thereof.

Compliance manager 145 may enable dynamic accessibility compliance of a website. In some examples, compliance manager 145 may be configured to perform the systems and methods described herein in conjunction with user interface 135 and application 140. User interface 135 may enable a user to interact with, control, or program one or more functions of compliance manager 145.

In some examples, compliance manager 145 enables a website to add accessibility compliance to external content (e.g., web content 165) that includes content separate from the page content (e.g., page content 160) of a web page. In some examples, compliance manager 145 may integrate accessibility compliance into page content 160 of the web page. In some examples, web content 165 may have no accessibility compliance or may not have the same level of accessibility compliance as that of the page content 160. Accordingly, compliance manager 145 may add accessibility compliance to the web content 165. In some examples, the techniques described herein may include compliance manager 145 providing the same level of accessibility compliance in the web content 165 as with the page content 160. Examples of website compliance provided by compliance manager 145 may include Americans with Disabilities Act (ADA) website compliance, or web content accessibility guidelines (WCAG) compliance, or Section 508 compliance, or any combination thereof.

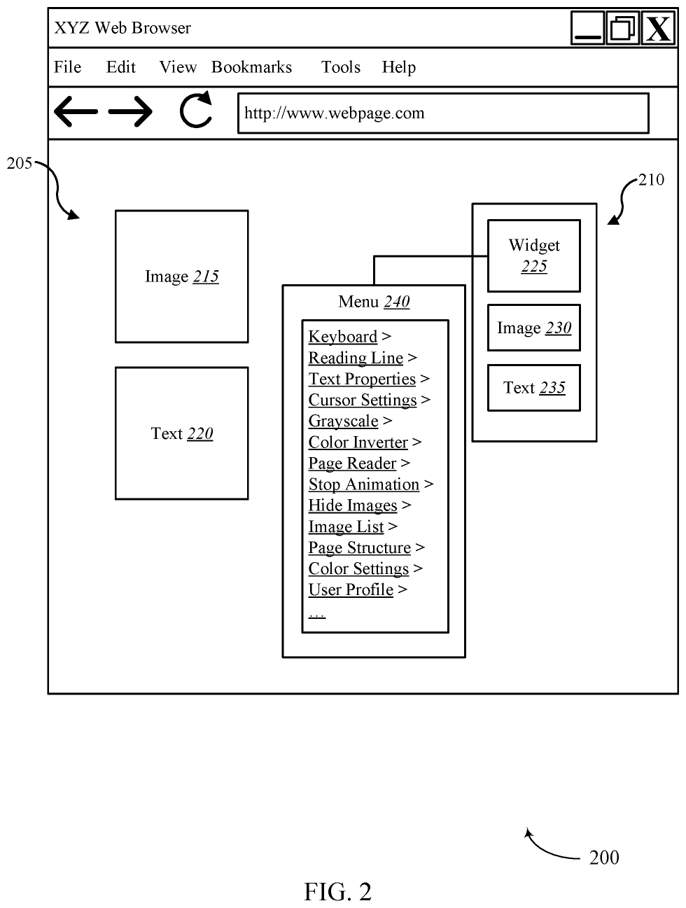

FIG. 2 illustrates an example of a web page 200 that supports dynamic accessibility compliance of a website in accordance with aspects of the present disclosure. In some examples, web page 200 may implement aspects of compliance system 100. In the illustrated example, web page 200 is displayed on a browser. The depicted browser may be an example of application 140. As shown, web page 200 may include page content 205 and web content 210.

In some examples, page content 205 may include one or more images (e.g., image 215), or text contained within or associated with web page 200 (e.g., text 220), or text fields, or software code, or source code (e.g., hypertext markup language (HTML), personal home page (PHP), JAVASCRIPT®, etc.), or web forms, or any combination thereof. In some examples, image 215 or at least a portion of text 220 may include a link (e.g., HTML link or hyperlink).

In some examples, web content 210 may include widget 225 (e.g., accessibility widget, software widget). In some examples, the widget 225 may include software code or source code (e.g., hypertext markup language (HTML), personal home page (PHP), JAVASCRIPT®, etc.). In some examples, compliance manager 145 may integrate widget 225 with web content 210. In some examples, compliance manager 145 integrating widget 225 with web content 210 may include compliance manager 145 embedding software code or source code of widget 225 with software code or source of web content 210.

In some examples, widget 225 may include a widget interface (e.g., interactive user interface, graphical button, interactive icon, text, image, hyperlink, etc.). In some examples, the widget interface may enable a user to interact with widget 225 to access functionality of the accessibility widget. In some examples, the widget interface may be configured to open a menu (e.g., menu 240) of widget 225. In the illustrated example, menu 240 may include keyboard settings, enabling a reading line, text properties (e.g., text spacing, font size, font type, etc.), cursor settings (e.g., cursor size, cursor color), grayscale settings (e.g., switching to or from a grayscale mode), color inverter settings (e.g., inverting one or more colors), page reader settings (e.g., text-to-speech, etc.), stop animation settings (e.g., enabling animation, disabling animation, disabling repetition of animation, etc.), hide images settings (e.g., enabling or disabling images to be shown such as image 215 or image 230), image list settings (e.g., enabling or disabling a listing of images such as image 215 or image 230), page structure settings, color settings, user profile, etc. In some cases, the user profile may include one or more user profiles, where each user profile includes user information and saved settings each user, etc.

In some examples, web content 210 may include one or more images (e.g., image 230), or text contained within or associated with web content 210 (e.g., text 235), or text fields, or software code, or source code (e.g., HTML, personal home page (PHP), JAVASCRIPT®, etc.), or web forms, or one or more images (e.g., image 230), or any combination thereof. In some examples, image 230 or at least a portion of text 235 may include a link (e.g., HTML link or hyperlink).

In some examples, compliance manager 145 may modify page content 205 to add or provide accessibility compliance. In some examples, compliance manager 145 may modify one or more aspects of page content 205 to ensure page content 205 is accessibility compliant. In some examples, compliance manager 145 may provide accessibility compliance for web content 210. In some examples, compliance manager 145 may modify one or more aspects of web content 210 to ensure web content 210 is accessibility compliant.

In some examples, compliance manager 145 providing accessibility compliance for page content 205 or web content 210 may include compliance manager 145 modifying one or more aspects of page content 205 or one or more aspects of web content 210. In some examples, compliance manager 145 providing accessibility compliance for page content 205 or web content 210 may include modifying a text spacing of text 220 or text 235, or modifying a text size of text 220 or text 235, or underlining a link (e.g., a link of image 215, or text 220, or image 230, or text 235), or magnifying at least a portion of image 215, or text 220, or image 230, or text 235, or modifying a color scheme, or converting one or more colors to grayscale, or inverting one or more colors of page content 205 or web content 210, or any combination thereof.

In some examples, compliance manager 145 providing accessibility compliance for page content 205 or web content 210 may include compliance manager 145 ensuring graphics do not flash more than three times per second, performing optical character recognition to convert text in an image to text characters, performing text to speech on converted text, or text 220, or text 235. In some examples, compliance manager 145 providing accessibility compliance for page content 205 or web content 210 may include compliance manager 145 enabling a user to navigate page content 205 or web content 210 just using a keyboard. In some examples, compliance manager 145 providing accessibility compliance for page content 205 or web content 210 may include compliance manager 145 determining a font color of text 220 or text 235 is too similar to a background color and switching to a dark font color (e.g., black font color) on a light background (e.g., white background color) or switching to a light font color (e.g., white font color) on a dark background (e.g., black background color).

In some examples, compliance manager 145 providing accessibility compliance for page content 205 or web content 210 may include compliance manager 145 enabling a user to pause content of page content 205 or web content 210, or enabling a user to slow down automatic scrolling or slideshow movements of page content 205 or web content 210. In some examples, compliance manager 145 providing accessibility compliance for page content 205 or web content 210 may include compliance manager 145 blocking auto-play on videos, or scrolling, or slideshow movements, etc. In some examples, compliance manager 145 providing accessibility compliance for page content 205 or web content 210 may include compliance manager 145 providing video interactions and enabling a video to be controlled using just keyboard functions.

In some examples, compliance manager 145 may select content (e.g., image 215, text 220, etc.) to include in the page content 205. In some examples, compliance manager 145 may select content (e.g., image 230, text 235, etc.) to include in the page content 205 (e.g., based on a user profile of menu 240). In some examples, compliance manager 145 may block content from being included in the web content based at least in part on the user profile (e.g., block image 215, or at least a portion of text 220, or image 230, or at least a portion of text 235, or scrolling, or video, or animation, or flashing graphics, etc.). In some examples, compliance manager 145 may delete, after closing web page 200, user data associated with web page 200 based at least in part on the user profile of menu 240.

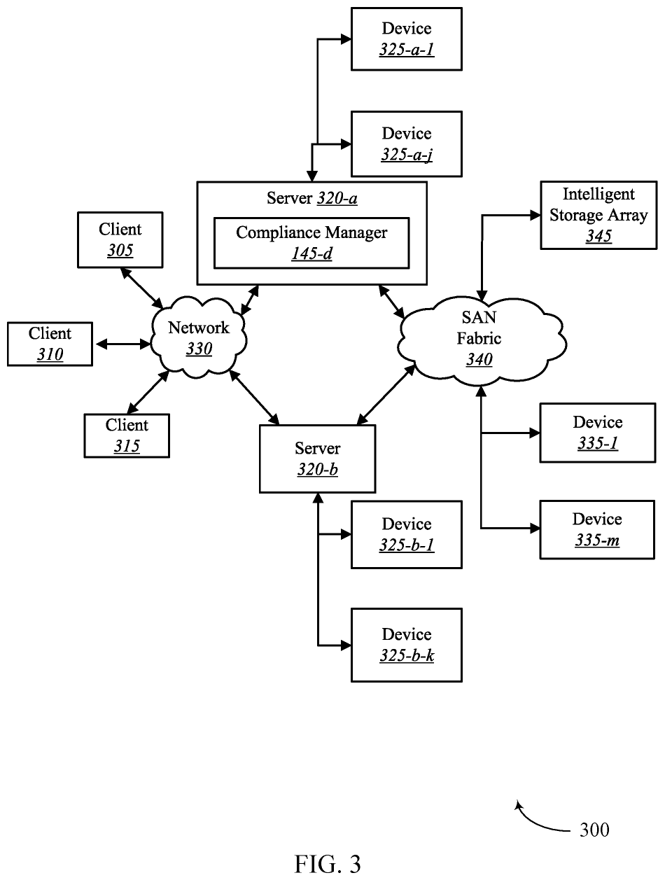

FIG. 3 illustrates an example of a network architecture 300 that supports dynamic accessibility compliance of a website in accordance with aspects of the present disclosure. In some examples, network architecture 300 may implement aspects of compliance system 100.

In the illustrated example, client systems 305, 310 and 315 of network architecture 300, as well as storage servers 320-a and 320-b of network architecture 300 (any of which can be implemented using a server or computing device of FIG. 1), are coupled to a network 330. In one example, compliance manager 145-d may be located within one of the storage servers 320-a, 320-b to implement the present systems and methods. Compliance manager 145-d may be one example of compliance manager 145 depicted in FIG. 1 or 2. The storage server 320-a is further depicted as having storage devices 325-a-l through 325-a-j directly attached, and storage server 320-b is depicted with storage devices 325-b-l through 325-b-k directly attached. SAN fabric 340 supports access to storage devices 335-l through 335-m by storage servers 320-a and 320-b, and so by client systems 305, 310 and 315 via network 330. Intelligent storage array 345 is also shown as an example of a specific storage device accessible via SAN fabric 340.

A network interface on each of client computer systems 305, 310 and 315 may be used to provide connectivity from each of client computer systems 305, 310 and 315 to network 330. Client systems 305, 310 and 315 are able to access information on storage server 320-a or 320-b using, for example, a web browser or other client software (not shown). Such a client allows client systems 305, 310 and 315 to access data hosted by storage server 320-a or 320-b or one of storage devices 325-a-l to 325-a-j, 325-b-l to 325-b-k, 335-l to 335-m or intelligent storage array 345. FIG. 3 depicts the use of a network such as the Internet for exchanging data, but the present systems and methods are not limited to the Internet or any particular network-based environment

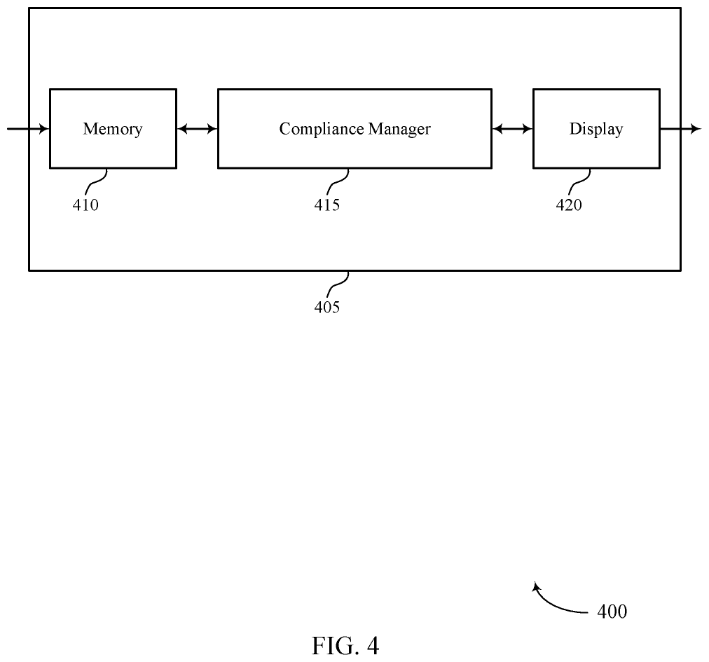

FIG. 4 shows a block diagram 400 of a device 405 that supports dynamic accessibility compliance of a website in accordance with aspects of the present disclosure. In some examples, device 405 may implement aspects of compliance system 100. The device 405 may be an example of aspects of a device as described herein (e.g., device 105, computing device 150, first server 110, second server 125, etc.). The device 405 may include a memory 410, a compliance manager 415, and a display 420. The device 405 may also include a processor. Each of these components may be in communication with one another (e.g., via one or more buses).

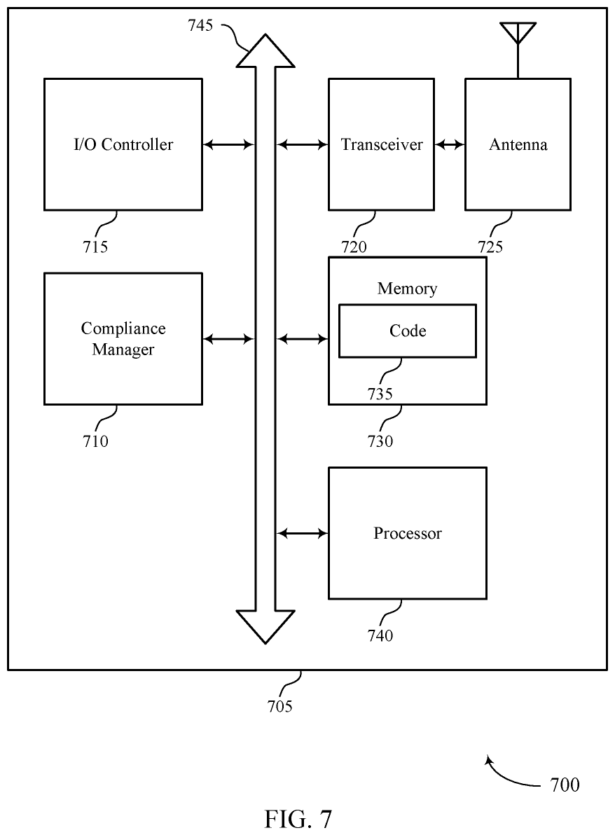

The memory 410 may store information (e.g., monitoring data, change detection data, analysis data, image metadata) generated by other components of device 405 such as compliance manager 415. For example, memory 410 may store one or more images samples that compliance manager 415 compares with an output of compliance manager 415. In some examples, the memory 410 may be collocated with one or more processors in a computing device (e.g., device 405). For example, the memory 410 may be an example of aspects of the memory 730 described with reference to FIG. 7. Memory 410 may comprise one or more computer-readable storage media. Examples of memory 410 include, but are not limited to, random access memory (RAM), static RAM (SRAM), dynamic RAM (DRAM), read-only memory (ROM), electrically erasable programmable read-only memory (EEPROM), compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor (e.g., compliance manager 415).

The compliance manager 415 may identify a request to load a web page on a web browser, identify a request from source code of the web page to retrieve web content, integrate an accessibility widget within the web content based on identifying the request from the source code to retrieve the web content, display the web content amongst page content of the web page, and modify at least one of the one or more aspects of the web content based on a user profile associated with the accessibility widget. The compliance manager 415 may be an example of aspects of the compliance manager 710 described herein.

The compliance manager 415, or its sub-components, may be implemented in hardware, code (e.g., software or firmware) executed by a processor, or any combination thereof. If implemented in code executed by a processor, the functions of the compliance manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The compliance manager 415, or its sub-components, may be physically located at various positions, including being distributed such that portions of functions are implemented at different physical locations by one or more physical components. In some examples, the compliance manager 415, or its sub-components, may be a separate and distinct component in accordance with various aspects of the present disclosure. In some examples, the compliance manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The display 420 may display graphics based on processing performed by compliance manager 415. In some examples, display 420 may or at least some of its sub-components may be implemented in hardware, software executed by a processor, firmware, or any combination thereof. When implemented in software executed by a processor, the functions of the display 420 or at least some of its various sub-components may be executed by compliance manager 415, which may include at least one of a general-purpose processor, a DSP, an ASIC, an FPGA or other programmable logic device, discrete gate or transistor logic, discrete hardware components, or any combination thereof designed to perform the functions described in the present disclosure.

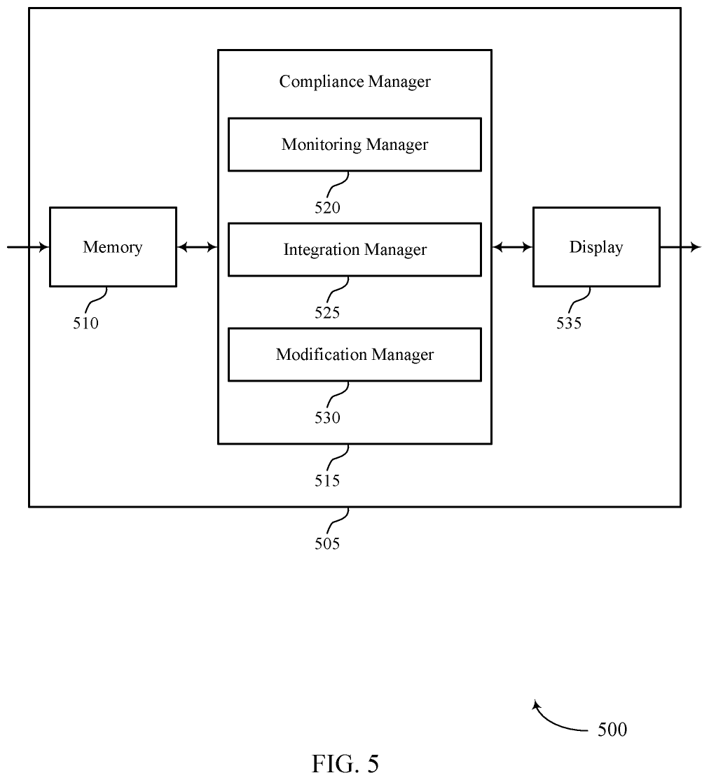

FIG. 5 shows a block diagram 500 of a device 505 that supports dynamic accessibility compliance of a website in accordance with aspects of the present disclosure. In some examples, device 405 may implement aspects of compliance system 100. The device 405 may be an example of aspects of a device as described herein (e.g., device 105, computing device 150, first server 110, second server 125, etc.). The device 505 may be an example of aspects of a device 405 as described herein. The device 505 may include a memory 510, a compliance manager 515, and a display 535. The device 505 may also include a processor. Each of these components may be in communication with one another (e.g., via one or more buses).

The memory 510 may receive, transmit, or store information, data, or signals generated by other components of the device 505. In some examples, the memory 510 may be collocated with one or more processors in a computing device (e.g., device 505). In some examples, the memory 510 may be an example of aspects of memory 730 described with reference to FIG. 7.

The compliance manager 515 may be an example of aspects of the compliance manager 415 as described herein. The compliance manager 515 may include a monitoring manager 520, an integration manager 525, and a modification manager 530. The compliance manager 515 may be an example of aspects of the compliance manager 710 described herein.

The monitoring manager 520 may identify a request to load a web page on a web browser and identify a request from source code of the web page to retrieve web content. The integration manager 525 may integrate an accessibility widget within the web content based on identifying the request from the source code to retrieve the web content and display the web content amongst page content of the web page. The modification manager 530 may modify at least one of the one or more aspects of the web content based on a user profile associated with the accessibility widget.

In some examples, display 535 may display graphics based on processing performed by compliance manager 515 (e.g., processing of alias instructions by compliance manager 515). In some examples, display 535 may or at least some of its sub-components may be implemented in hardware, software executed by a processor, firmware, or any combination thereof. When implemented in software executed by a processor, the functions of the display 535 or at least some of its various sub-components may be executed by compliance manager 515, which may include at least one of a general-purpose processor, a DSP, an ASIC, an FPGA or other programmable logic device, discrete gate or transistor logic, discrete hardware components, or any combination thereof designed to perform the functions described in the present disclosure.

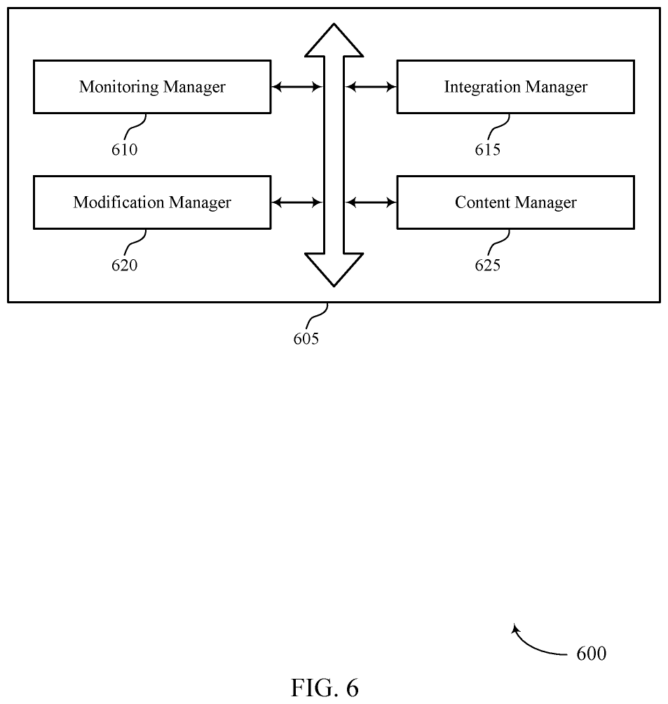

FIG. 6 shows a block diagram 600 of a compliance manager 605 that supports dynamic accessibility compliance of a website in accordance with aspects of the present disclosure. The compliance manager 605 may be an example of aspects of a compliance manager 415, a compliance manager 515, or a compliance manager 710 described herein. The compliance manager 605 may include a monitoring manager 610, an integration manager 615, a modification manager 620, and a content manager 625. Each of these modules may communicate, directly or indirectly, with one another (e.g., via one or more buses).

The monitoring manager 610 may identify a request to load a web page on a web browser. In some examples, the monitoring manager 610 may identify a request from source code of the web page to retrieve web content.

The integration manager 615 may integrate an accessibility widget within the web content based on identifying the request from the source code to retrieve the web content.

In some examples, the integration manager 615 may display the web content amongst page content of the web page. In some examples, the integration manager 615 may automatically read aloud, based on the user profile, text of the web content or text of the page content using a text-to-speech computer process of the accessibility widget. In some examples, integrating the accessibility widget into the web content includes embedding source code of the accessibility widget into source code of the web content.

In some examples, displaying an interactive user interface of the accessibility widget that is configured to open a menu of the accessibility widget, where the menu includes settings of the user profile. In some examples, loading the web page includes downloading and displaying the page content in the web browser.

In some cases, at least a portion of the page content is downloaded from a first server, and where at least a portion of the web content is retrieved from a second server different from the first server. The modification manager 620 may modify at least one of the one or more aspects of the web content based on a user profile associated with the accessibility widget. In some examples, the modification manager 620 may modify one or more aspects of the page content based on the user profile associated with the accessibility widget.

In some examples, modifying the one or more aspects of the web content or the one or more aspects of the page content includes at least one of modifying a text spacing, or modifying a text size, or underlining a link, or magnifying at least a portion of text, or modifying a color scheme, or converting one or more colors to grayscale, or inverting one or more colors, or any combination thereof.

The content manager 625 may select content to include in the web content based on the user profile. In some examples, the content manager 625 may block content from being included in the web content based on the user profile. In some examples, the content manager 625 may delete, after closing the web page, user data associated with the web page based on the user profile.

FIG. 7 shows a diagram of a system 700 including a device 705 that supports dynamic accessibility compliance of a website in accordance with aspects of the present disclosure. The device 705 may be an example of or include the components of device 405, device 505, or a device as described herein. The device 705 may include components for bi-directional voice and data communications including components for transmitting and receiving communications, including a compliance manager 710, an I/O controller 715, a transceiver 720, an antenna 725, memory 730, a processor 740, and a coding manager 750. These components may be in electronic communication via one or more buses (e.g., bus 745).

The compliance manager 710 may identify a request to load a web page on a web browser, identify a request from source code of the web page to retrieve web content, integrate an accessibility widget within the web content based on identifying the request from the source code to retrieve the web content, display the web content amongst page content of the web page, and modify at least one of the one or more aspects of the web content based on a user profile associated with the accessibility widget.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described herein. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

The memory 730 may include RAM and ROM. The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting dynamic accessibility compliance of a website).

The code 735 may include instructions to implement aspects of the present disclosure, including instructions to support dynamic accessibility compliance of a website. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

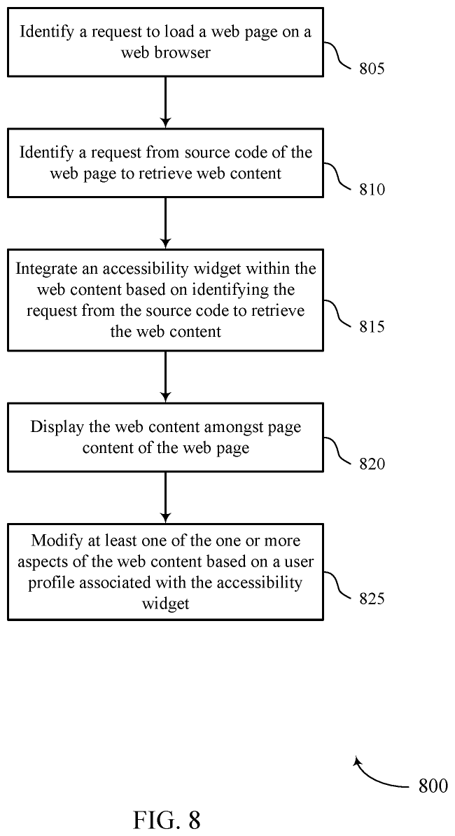

FIG. 8 shows a flowchart illustrating a method 800 that supports dynamic accessibility compliance of a website in accordance with aspects of the present disclosure.

The operations of method 800 may be implemented by a device or its components as described herein. For example, the operations of method 800 may be performed by a compliance manager as described with reference to FIGS. 4 through 7. In some examples, a device may execute a set of instructions to control the functional elements of the device to perform the functions described herein. Additionally or alternatively, a device may perform aspects of the functions described herein using special-purpose hardware.

At 805, the device may identify a request to load a web page on a web browser. The operations of 805 may be performed according to the methods described herein. In some examples, aspects of the operations of 805 may be performed by a monitoring manager as described with reference to FIGS. 4 through 7.

At 810, the device may identify a request from source code of the web page to retrieve web content. The operations of 810 may be performed according to the methods described herein. In some examples, aspects of the operations of 810 may be performed by a monitoring manager as described with reference to FIGS. 4 through 7.

At 815, the device may integrate an accessibility widget within the web content based on identifying the request from the source code to retrieve the web content. The operations of 815 may be performed according to the methods described herein. In some examples, aspects of the operations of 815 may be performed by an integration manager as described with reference to FIGS. 4 through 7.

At 820, the device may display the web content amongst page content of the web page. The operations of 820 may be performed according to the methods described herein. In some examples, aspects of the operations of 820 may be performed by an integration manager as described with reference to FIGS. 4 through 7.

At 825, the device may modify at least one of the one or more aspects of the web content based on a user profile associated with the accessibility widget. The operations of 825 may be performed according to the methods described herein. In some examples, aspects of the operations of 825 may be performed by a modification manager as described with reference to FIGS. 4 through 7.

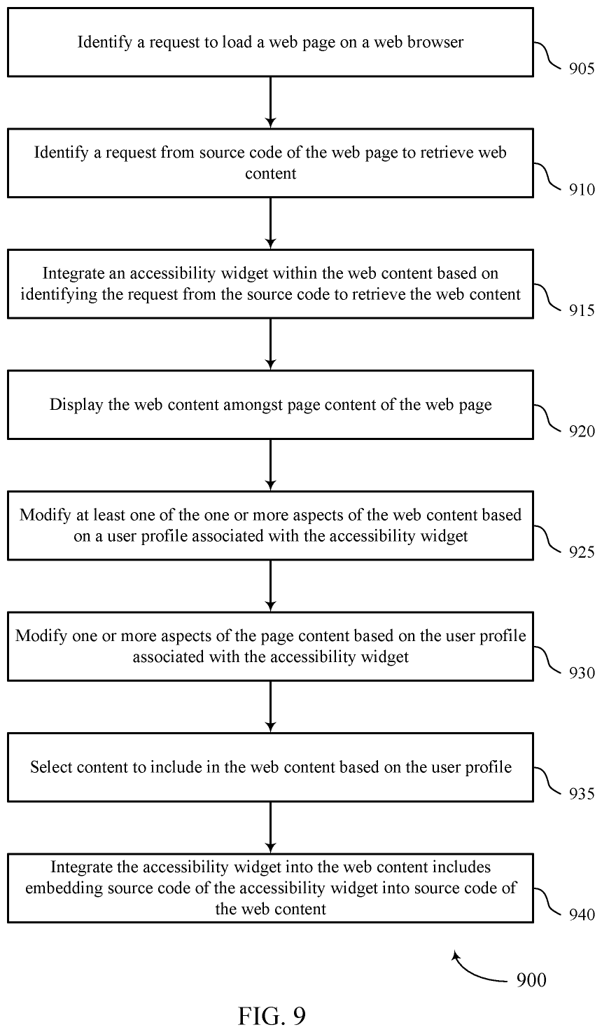

FIG. 9 shows a flowchart illustrating a method 900 that supports dynamic accessibility compliance of a website in accordance with aspects of the present disclosure. The operations of method 900 may be implemented by a device or its components as described herein. For example, the operations of method 900 may be performed by a compliance manager as described with reference to FIGS. 4 through 7. In some examples, a device may execute a set of instructions to control the functional elements of the device to perform the functions described herein. Additionally or alternatively, a device may perform aspects of the functions described herein using special-purpose hardware.

At 905, the device may identify a request to load a web page on a web browser. The operations of 905 may be performed according to the methods described herein. In some examples, aspects of the operations of 905 may be performed by a monitoring manager as described with reference to FIGS. 4 through 7.

At 910, the device may identify a request from source code of the web page to retrieve web content. The operations of 910 may be performed according to the methods described herein. In some examples, aspects of the operations of 910 may be performed by a monitoring manager as described with reference to FIGS. 4 through 7.

At 915, the device may integrate an accessibility widget within the web content based on identifying the request from the source code to retrieve the web content. The operations of 915 may be performed according to the methods described herein. In some examples, aspects of the operations of 915 may be performed by an integration manager as described with reference to FIGS. 4 through 7.

At 920, the device may display the web content amongst page content of the web page. The operations of 920 may be performed according to the methods described herein. In some examples, aspects of the operations of 920 may be performed by an integration manager as described with reference to FIGS. 4 through 7.

At 925, the device may modify at least one of the one or more aspects of the web content based on a user profile associated with the accessibility widget. The operations of 925 may be performed according to the methods described herein. In some examples, aspects of the operations of 925 may be performed by a modification manager as described with reference to FIGS. 4 through 7.

At 930, the device may modify one or more aspects of the page content based on the user profile associated with the accessibility widget. The operations of 930 may be performed according to the methods described herein. In some examples, aspects of the operations of 930 may be performed by a modification manager as described with reference to FIGS. 4 through 7.

At 935, the device may select content to include in the web content based on the user profile. The operations of 935 may be performed according to the methods described herein. In some examples, aspects of the operations of 935 may be performed by a content manager as described with reference to FIGS. 4 through 7.

At 940, the device may integrate the accessibility widget into the web content includes embedding source code of the accessibility widget into source code of the web content. The operations of 940 may be performed according to the methods described herein. In some examples, aspects of the operations of 940 may be performed by an integration manager as described with reference to FIGS. 4 through 7.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications compliance system 100 and/or web page 200 of FIGS. 1 and 2, respectively—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for dynamic accessibility compliance of a website, comprising:
identifying a request to load a web page on a web browser;
identifying a request from source code of the web page to retrieve web content;
integrating an accessibility widget within the web content based at least in part on identifying the request from the source code to retrieve the web content;
displaying the web content amongst page content of the web page; and
modifying at least one of the one or more aspects of the web content based at least in part on a user profile associated with the accessibility widget.

2. The method of claim 1, further comprising:
modifying one or more aspects of the page content based at least in part on the user profile associated with the accessibility widget.

3. The method of claim 2, wherein:
modifying the one or more aspects of the web content or the one or more aspects of the page content comprises at least one of modifying a text spacing, or modifying a text size, or underlining a link, or magnifying at least a portion of text, or modifying a color scheme, or converting one or more colors to grayscale, or inverting one or more colors, or any combination thereof.

4. The method of claim 2, further comprising:
automatically reading aloud, based at least in part on the user profile, text of the web content or text of the page content using a text-to-speech computer process of the accessibility widget.

5. The method of claim 1, further comprising:
selecting content to include in the web content based at least in part on the user profile.

6. The method of claim 1, further comprising:
blocking content from being included in the web content based at least in part on the user profile.

7. The method of claim 1, further comprising:
deleting, after closing the web page, user data associated with the web page based at least in part on the user profile.

8. The method of claim 1, wherein:
integrating the accessibility widget into the web content comprises embedding source code of the accessibility widget into source code of the web content.

9. The method of claim 1, wherein displaying the web content comprises:
displaying an interactive user interface of the accessibility widget that is configured to open a menu of the accessibility widget, wherein the menu comprises settings of the user profile.

10. The method of claim 1, wherein:
loading the web page comprises downloading and displaying the page content in the web browser.

11. The method of claim 1, wherein at least a portion of the page content is downloaded from a first server, and wherein at least a portion of the web content is retrieved from a second server different from the first server.

12. An apparatus for dynamic accessibility compliance of a website, comprising:
a processor,
memory coupled with the processor; and
instructions stored in the memory and executable by the processor to cause the apparatus to:
identify a request to load a web page on a web browser;
identify a request from source code of the web page to retrieve web content;
integrate an accessibility widget within the web content based at least in part on identifying the request from the source code to retrieve the web content;
display the web content amongst page content of the web page; and
modify at least one of the one or more aspects of the web content based at least in part on a user profile associated with the accessibility widget.

13. The apparatus of claim 12, wherein the instructions are further executable by the processor to cause the apparatus to:
modify one or more aspects of the page content based at least in part on the user profile associated with the accessibility widget.

14. The apparatus of claim 13, wherein:
modify the one or more aspects of the web content or the one or more aspects of the page content comprises at least one of modifying a text spacing, or modifying a text size, or underlining a link, or magnifying at least a portion of text, or modifying a color scheme, or converting one or more colors to grayscale, or inverting one or more colors, or any combination thereof.

15. The apparatus of claim 13, wherein the instructions are further executable by the processor to cause the apparatus to:
automatically read aloud, based at least in part on the user profile, text of the web content or text of the page content using a text-to-speech computer process of the accessibility widget.

16. The apparatus of claim 12, wherein the instructions are further executable by the processor to cause the apparatus to:
select content to include in the web content based at least in part on the user profile.

17. The apparatus of claim 12, wherein the instructions are further executable by the processor to cause the apparatus to:
block content from being included in the web content based at least in part on the user profile.

18. The apparatus of claim 12, wherein the instructions are further executable by the processor to cause the apparatus to:
delete, after closing the web page, user data associated with the web page based at least in part on the user profile.

19. A non-transitory computer-readable medium storing code for dynamic accessibility compliance of a website, the code comprising instructions executable by a processor to:
identify a request to load a web page on a web browser;
identify a request from source code of the web page to retrieve web content;
integrate an accessibility widget within the web content based at least in part on identifying the request from the source code to retrieve the web content;
display the web content amongst page content of the web page; and
modify at least one of the one or more aspects of the web content based at least in part on a user profile associated with the accessibility widget.

20. The non-transitory computer-readable medium of claim 19, wherein the instructions are further executable to:
modify one or more aspects of the page content based at least in part on the user profile associated with the accessibility widget.
